(19) United States
(12) Patent Application Publication
(10) Pub. No.: US 2012/0163222 A1
(43) Pub. Date: Jun. 28, 2012

(54) SYSTEM AND METHOD FOR LOCATING A WIRELESS DEVICE IN A WIMAX NETWORK USING UPLINK SIGNALS

(76) Inventors: Tariqul Islam, Germantown, MD (US); Anthony James Winterbottom, Gwynneville (AU)

(21) Appl. No.: 13/388,379

(22) PCT Filed: Aug. 14, 2009
(86) PCT No.: PCT/US09/53909

§ 371 Date: Feb. 1, 2012

(51) Int. Cl. H04W 24/00; H04W 72/04

(52) U.S. Cl. 370/252

(57) ABSTRACT

A system and method for estimating a location of a wireless device receiving signals from plural nodes of a Worldwide Interoperability for Microwave Access (“WiMAX”) communication system. Contention or non-contention based ranging may be allocated to the wireless device, and a first signal may be transmitted from at least one of the plural nodes to the wireless device. Tipping information may then be transmitted to one or more location measurement units, and a ranging signal transmitted from the wireless device in response to the first signal. Uplink signal time of arrival measurements of the ranging signal may be performed as a function of the tipping information, and a location of the wireless device estimated as a function of the determined uplink measurements. Downlink signal measurements of first signals received by the wireless device from the plural nodes may also be determined and a location of the wireless device determined from the uplink and/or downlink measurements.

### RELATED APPLICATIONS

The instant application is related to and co-pending with International Patent Application No. PCT/US2009/052876, entitled, “System and Method for Hybrid Location in a UMTS Network,” filed Aug. 5, 2009, the entirety of which is incorporated herein by reference. The instant application is related to and co-pending with International Patent Application No. PCT/US2009/052879, entitled, “System and Method for Hybrid Location in a CDMA2000 Network,” filed Aug. 5, 2009, the entirety of which is incorporated herein by reference. The instant application is related to and co-pending with International Patent Application No. PCT/US2009/052884, entitled, “System and Method for Hybrid Location in an LTE Network,” filed Aug. 5, 2009, the entirety of which is incorporated herein by reference. The instant application is related to and co-pending with International Patent Application No. PCT/US2009/053919, entitled, “System and Method for Hybrid Location in a WiMAX Network,” filed Aug. 14, 2009, the entirety of which is incorporated herein by reference.

### BACKGROUND

The location of a mobile, wireless or wired device is a useful and sometimes necessary part of many services. The precise methods used to determine location are generally dependent on the type of access network and the information that can be obtained from the device. For example, in wireless networks, a range of technologies may be applied for location determination, the most basic of which uses the location of the radio transmitter as an approximation. The Internet Engineering Task Force (“IETF”) and other standards forums have defined various architectures and protocols for acquiring location information for location determination. In one exemplary network, e.g., a Voice over Internet Protocol (“VoIP”) network, a location server (“LS”) may be automatically discovered and location information retrieved using network specific protocols.

Other exemplary wireless networks are a World Interoperability for Microwave Access (“WiMAX”) network and a Long Term Evolution (“LTE”) network. Generally, WiMAX is intended to reduce the barriers to widespread broadband access deployment with standards-compliant wireless solutions engineered to deliver ubiquitous fixed and mobile services such as VoIP, messaging, video, streaming media, and other IP traffic. WiMAX enables delivery of last-mile broadband access without the need for direct line of sight. Ease of installation, wide coverage, and flexibility makes WiMAX suitable for a range of deployments over long-distance and regional networks, in addition to rural or underdeveloped areas where wired and other wireless solutions are not easily deployed and line of sight coverage is not possible.

LTE is generally a 4G wireless technology and is considered the next in line in the GSM evolution path after UMTS/HSPDA 3G technologies. LTE builds on the 3GPP family including GSM, GPRS, EDGE, WCDMA, HSPA, etc., and is an all-IP standard like WiMAX. LTE is based on orthogonal frequency division multiplexing (“OFDM”) Radio Access technology and multiple input multiple output (“MIMO”) antenna technology. LTE provides higher data transmission rates while efficiently utilizing the spectrum thereby supporting a multitude of subscribers than is possible with pre-4G spectral frequencies. LTE is all-IP permitting applications such as real time voice, video, gaming, social networking and location-based services. LTE networks may also co-operate with circuit-switched legacy networks and result in a seamless network environment and signals may be exchanged between traditional networks, the new 4G network and the Internet seamlessly.

The original version of the standard on which WiMAX is based (IEEE 802.16) specified a physical layer operating in the 10 to 66 GHz range. 802.16a, updated in 2004 to 802.16-2004, added specifications for the 2 to 11 GHz range. 802.16-2004 was updated by 802.16e-2005 in 2005 and uses scalable orthogonal frequency division multiple access (“SOFDMA”) as opposed to the OFDM version with 256 sub-carriers (of which 200 are used) in 802.16d. More advanced versions, including 802.16e, also bring Multiple Antenna Support through MIMO functionality. This brings potential benefits in terms of coverage, self installation, power consumption, frequency re-use and bandwidth efficiency. Furthermore, 802.16e also adds a capability for full mobility support. Most commercial interest is in the 802.16d and 802.16e standards, since the lower frequencies used in these variants suffer less from inherent signal attenuation and therefore gives improved range and in-building penetration. Already today, a number of networks throughout the world are in commercial operation using WiMAX equipment compliant with the 802.16d standard.

The WiMAX Forum has provided an architecture defining how a WiMAX network connects with other networks, and a variety of other aspects of operating such a network, including address allocation, authentication, etc. It is important to note that a functional architecture may be designed into various hardware configurations rather than fixed configurations. For example, WiMAX architectures according to embodiments of the present subject matter are flexible enough to allow remote/mobile stations of varying scale and functionality and base stations of varying size. There is, however, a need in the art to overcome the limitations of the prior art and provide a novel system and method for locating WiMAX and LTE subscriber stations. While LTE protocol is being defined in the 3GPP standards as the next generation mobile broadband technology, there is also a need for mobile subscriber or user equipment (“UE”) location in LTE networks for compliance with the FCC E-911 requirements and for other location based services. To obviate the deficiencies in the prior art one embodiment of the present subject matter provides a hybrid mobile location method that uses both uplink and downlink signal measurements in an exemplary communications network, such as, but not limited to, a WiMAX, UMTS, CDMA2000, and/or LTE network.

One embodiment of the present subject matter provides a method for estimating a location of a wireless device receiving signals from plural nodes of a WiMAX communication system. The method may comprise determining downlink signal measurements including a range of the wireless device from a serving node, an OTDOA measurement of a signal from one or more neighboring nodes, and a transmission time of the signal from the one or more neighboring nodes. The method may further include determining uplink signal measurements including a TOA measurement of a ranging signal from the wireless device, and a timing adjust parameter of the wireless device. A location of the wireless device may then be estimated as a function of the determined downlink and uplink signal measurements.

Another embodiment of the present subject matter may provide a method for estimating a location of a wireless device receiving signals from plural nodes of a WiMAX communication system. The method may comprise determining downlink signal measurements of first signals received by the wireless device from the plural nodes, and transmitting a second signal from at least one of the plural nodes to the wireless device. A third signal may be transmitted from the wireless device in response to the second signal, and uplink signal measurements determined as a function of the third signal. A location of the wireless device may then be estimated as a function of the determined downlink and uplink measurements.

A further embodiment of the present subject matter provides a system for estimating a location of a wireless device receiving signals from a plurality of nodes of a communication system. The system may include circuitry for determining downlink signal measurements of first signals received by the wireless device from the plural nodes and a transmitter for transmitting a second signal from at least one of the plural nodes to the wireless device. The system may also include a receiver for receiving a third signal transmitted from the wireless device in response to the second signal and circuitry for determining uplink signal measurements as a function of the third signal. The system may include circuitry for estimating a location of the wireless device as a function of the determined downlink and uplink measurements.

One embodiment of the present subject matter provides a method for estimating a location of a wireless device receiving signals from plural nodes of a WiMAX communication system. A first signal may be transmitted from at least one of the plural nodes to the wireless device and contention or non-contention based ranging allocated to the wireless device. Tipping information may then be transmitted to one or more location measurement units, and a ranging signal transmitted from the wireless device in response to the first signal. Uplink signal time of arrival measurements of the ranging signal may be performed as a function of the tipping information, and a location of the wireless device estimated as a function of the determined downlink and uplink measurements. Another embodiment may include determining downlink signal measurements of second signals received by the wireless device from the plural nodes and estimating the location as a function thereof.

Another embodiment of the present subject matter provides a method for estimating a location of a wireless device receiving signals from plural nodes of a WiMAX communication system. The method may include transmitting a first signal from at least one of the plural nodes to the wireless device, and a plurality of ranging signals may be transmitted from the wireless device in response to the first signal. Uplink signal TOA measurements of the ranging signal may be performed, and a location of the wireless device estimated as a function of the determined downlink and uplink measurements. The method may also include in another embodiment determining downlink signal measurements including one or more of a range of the wireless device from a serving node, an OTDOA measurement of a signal from one or more neighboring nodes, and a transmission time of the signal from the one or more neighboring nodes.

An additional embodiment of the present subject matter provides a method for estimating a location of a wireless device receiving signals from plural nodes of a WiMAX communication system. The method may include transmitting a first signal from at least one of the plural nodes to the wireless device, and a ranging signal transmitted from the wireless device in response to the first signal. The power or ranging sub-carrier power of the ranging signal may be increased to thereby increase a probability of detection of the ranging signal. Uplink signal TOA measurements of the ranging signal may be performed, and a location of the wireless device estimated as a function of the determined downlink and uplink measurements. In another embodiment, the method may include determining downlink signal measurements including one or more of a range of the wireless device from a serving node, an OTDOA measurement of a signal from one or more neighboring nodes, and a transmission time of the signal from the one or more neighboring nodes and estimating the location of the wireless device therefrom.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1 is a diagram of an exemplary access network model.

FIG. 2 is a high level diagram of one embodiment of the present subject matter.

FIG. 3 is a more detailed diagram of an exemplary WiMAX Location Based Service network architecture.

FIG. 4 is a diagram illustrating one method for hybrid signal based location in a WiMAX network.

FIG. 5 is a diagram of another embodiment of the present subject matter.

FIG. 6 is a diagram of one embodiment of the present subject matter.

FIG. 7 is a diagram of another embodiment of the present subject matter.

FIG. 8 is a diagram of a further embodiment of the present subject matter.

FIG. 9 is a diagram of an additional embodiment of the present subject matter.

FIG. 10 is an illustration of an exemplary location technique according to one embodiment of the present subject matter.

### DETAILED DESCRIPTION

With reference to the figures where like elements have been given like numerical designations to facilitate an understanding of the present subject matter, the various embodiments of a system and method for locating a wireless device in a WiMAX network using uplink signals are herein described.

Embodiments of the present subject matter may provide handsets capable of OTDOA measurements, network support of OTDOA measurements, GPS trained LMUs deployed in the network, network support of providing uplink tipping information and OTDOA measurements to a location server (“LS”).

Generally, a WiMAX or LTE subscriber or mobile station may provide to a communications network round trip delay (“RTD”) information of an anchor base station's downlink and uplink signals and the observed relative delays of the neighboring base stations' downlink and uplink signals. The phrases subscriber station, mobile station, mobile appliance, wireless device, and user equipment (“UE”) are used interchangeably throughout this document and such should not limit the scope of the claims appended herewith. Further, the terms station and device are also used interchangeably throughout this document and such should not limit the scope of the claims appended herewith. The respective WiMAX or LTE network may utilize this data for hand-off operations; however, embodiments of present subject matter may determine from this data range rings from the anchor and/or serving base station (“BS”) or node and/or location hyperbolas between the reported BSs, if the BS timings are known.

In one embodiment of the present subject matter, an exemplary system may include a location server (“LS”), such as a Location Information Server (“LIS”), which is generally a network server that provides devices with information about their location. Devices that require location information may be able to request their location from the LS. In the architectures developed by the IETF, NENA and other standards forums, the LS may be made available in an IP access network connecting one or more target devices to the Internet. In other modes of operation, the LS may also provide location information to other requesters relating to a target device.

To determine location information for a target device, an exemplary LS may utilize a range of methods. The LS may use knowledge of network topology, private interfaces to networking devices like routers, switches and base stations, and location determination algorithms. Exemplary algorithms may include known algorithms to determine the location of a mobile device as a function of satellite information, satellite assistance data, various downlink or uplink algorithms such as, but not limited to, time difference of arrival (“TDOA”), time of arrival (“TOA”), angle of arrival (“AOA”), round trip delay (“RTD”), signal strength, advanced forward link trilateration (“AFLT”), enhanced observed time difference (“EOTD”), observed time difference of arrival (“OTDOA”), uplink-TOA and uplink-TDOA, enhanced cell/sector and cell-ID, etc., and hybrid combinations thereof.

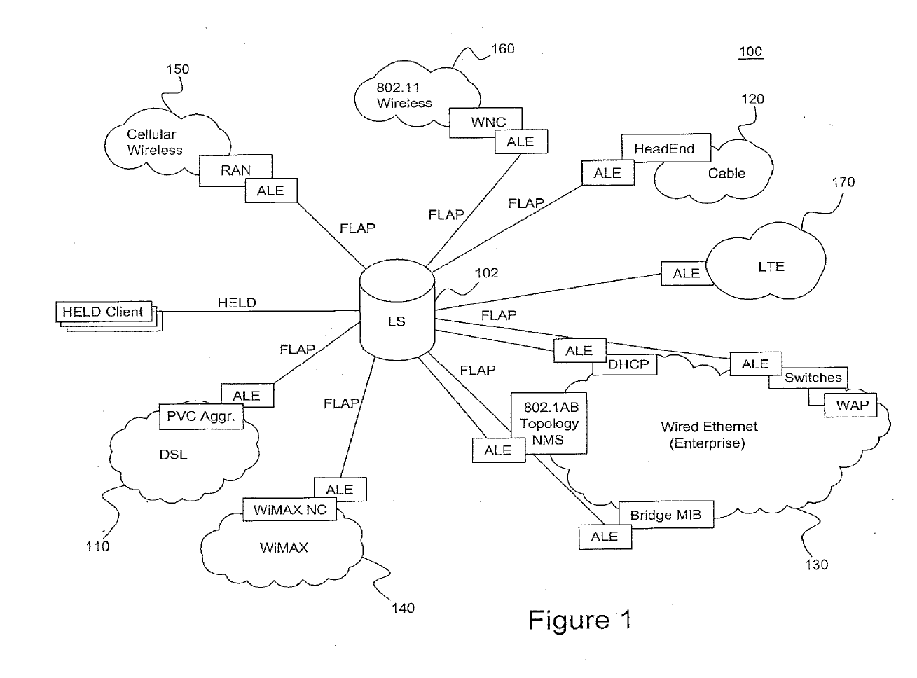

FIG. 1 is a diagram of an exemplary access network model. With reference to FIG. 1, an exemplary access network model 100 may include one or more LSs 102 connected to one or more access networks, 110-170. An access network refers to a network that provides a connection between a device and the Internet. This may include the physical infrastructure, cabling, radio transmitters, switching and routing nodes and servers. The access network may also cover services required to enable IP communication including servers that provide addressing and configuration information such as DHCP and DNS servers, Examples of different types of access networks include, but are not limited to, DSL 110, cable 120, WiFi, wired Ethernet 130, WiMAX 140, cellular packet services 150, and 802.11 wireless 160, LTE 170, among others. An exemplary LS 102 may be implemented on multiple processing units, any one of which may provide location information for a target device from a first site, a second site and/or additional sites. Therefore, an exemplary LS 102 may provide high availability by having more than one processing unit at a first site and by having multiple processing units at a second site for copying or backup purposes in the event a site or a processing unit fails.

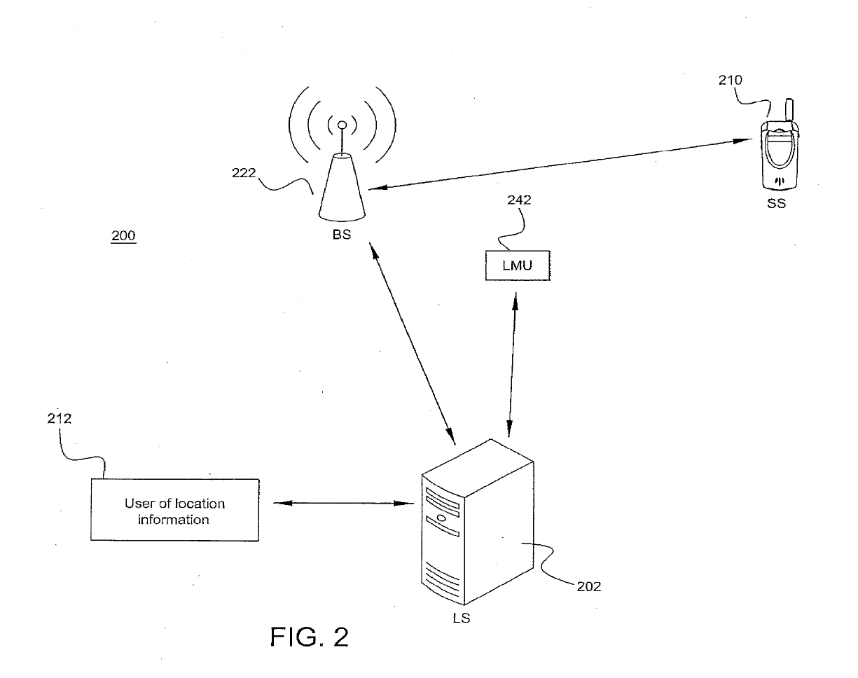

FIG. 2 is a high level diagram of one embodiment of the present subject matter. With reference to FIG. 2, an exemplary wireless network or system 200 may include an LS 202 in communication with one or more base stations (“BS”) 222, one or more location measurement units (LMUs) 242. One or more mobile or subscriber stations or devices 210 may be in communication with the LS 202 via the one or more BSs 222. A recipient or user 212 of location information may request the LS 202 to locate a subscriber station 210. The LS 202 may then request the serving BS 222 to provide network measurement information. The BS 222 receives the data from the target subscriber station 210 and provides the data to the LS 202. The LS 202 may compute the location of the target station or device 210. Once the location is computed, the LS 202 may provide the location information to the requesting user 212.

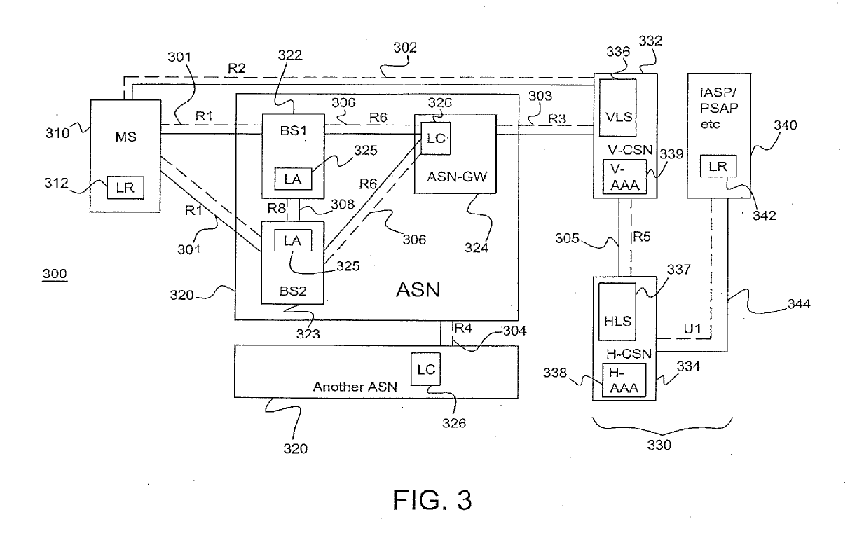

FIG. 3 is a more detailed diagram of an exemplary WiMAX Location Based Service (“LBS”) network architecture 300. With reference to FIG. 3, the WiMAX forum defines a number of functional entities and interfaces between those entities. An exemplary network architecture 300 includes one or more access service networks (“ASN”) 320, each having one or more base stations (“BS”) 322, 323 and one or more ASN gateways (“ASN-GW”) 324 forming the radio access network at the edge thereof. One or more mobile stations or devices 310, such as a WiMAX device, having a location requester 312 may be in communication with the ASN 320 via one or more BSs 322, 323 over an R1 interface 301. BSs 322, 323 are responsible for providing the air interface to the device 310. Additional functions may, of course, be part of BSs 322, 323, such as micromobility management functions, handoff triggering, tunnel establishment, radio resource management, QoS policy enforcement, traffic classification, Dynamic Host Control Protocol (“DHCP”) proxy, key management, session management, and multicast group management, to name a few. BSs 322, 323 communicate with one another via resident location agents (“LA”) 325 over an R8 interface 308. LAs 325 are generally responsible for measurements and reporting and may communicate with the device 310 to collect measurements. BSs 322, 323 also communicate with the ASN-GWs 324 via a location controller (“LC”) 326 in the ASN-GW 324 over an R6 interface 306. LCs 326 generally collect location measurements and forward these measurements on a request response basis to an LS in a selected connectivity service network (“CSN”) 330.

The ASN-GW 324 generally acts as a layer 2 traffic aggregation point within an ASN 320. Additional functions that may be part of the ASN-GW 324 include, but are not limited to, intra-ASN location management and paging, radio resource management and admission control, caching of subscriber profiles and encryption keys, AAA client functionality, establishment and management of mobility tunnel with BSs, QoS and policy enforcement, foreign agent functionality for mobile IP and routing to a selected CSN. Communication between ASNs 320 occurs over an R4 interface 304. It should also be noted that a Public Safety Answering Point (“PSAP”) or an Internet Application Service Provider (“iASP”) 340 may also include a location requester 342 and may be in communication with a home CSN 334 over a U1 interface 344. The U1 interface 344 may also be in communication with a visited CSN (“V-CSN”) 332 and hence the visited location server and communication from the applications (PSAPs included) may be to either the visited or the home location servers.

A third portion of the network includes the CSN 330. The CSN may be a visited network having a visited-CSN (“V-CSN”) 332 or a home network having a home-CSN (“H-CSN”) 334, collectively CSNs 330. These CSNs 330 provide IP connectivity and generally all the IP core network functions in the network 300. For example, the CSN 330 provides connectivity to the Internet, ASP, other public networks and corporate networks. The CSN 330 is owned by a network service provider (“NSP”) and includes Authentication Authorization Access (“AAA”) servers (home-AAA 338 and visited-AAA 339 servers) that support authentication for the devices, users, and specific services. The CSN 330 also provides per user policy management of QoS and security. The CSN 330 is also responsible for IP address management, support for roaming between different NSPs, location management between ASNs 320, and mobility and roaming between ASNs 320, to name a few. Communication between the ASN 320 and a CSN 330 occurs via the respective ASN-GW 324 over an R3 interface 303.

One entity within a CSN 330 is a an LS. Depending upon whether the device 310 is roaming and in direct communication with a remote network or in direct communication with a home network, the LS may be a visited-LS (“V-LS”) 336 or a home-LS (“H-LS”) 337. The role of the LS is to provide location information about a WiMAX device 310 in the network 300. Communication between the WiMAX device 310 and the LS 336, 337 is performed over an R2 interface 302.

It should be noted that there are several location determination methods supported by the above-described network architecture 300. For example, a location server may utilize 802.16m MAC and PHY features to estimate a location of a mobile appliance when GPS is not available via an R2 interface, e.g., indoors, or be able to faster and more accurately acquire GPS signals for location determination. The network 300 may make the GPS assistance data, including GPS Almanac data and Ephemeris data, available to the device 310 using the R2 interface and HELD or SUPL.

Non-GPS-Based supported methods may rely on the role of the serving and neighboring BSs or other components. For example, in a downlink (“DL”) scenario, a device 310 may receive existing signals (e.g., preamble sequence) or new signals designed specifically for the LBS measurements, if it is needed to meet the requirement from the serving/attached BS and multiple neighboring BSs 322, 323. The BSs 322, 323 are able to coordinate transmission of their sequences using different time slots or different OFDM subcarriers. The device 310 may accurately determine the required measurements, even in the presence of multipath channel and heavy interference environment, and then estimate its location accordingly. In an uplink (“UL”) scenario, various approaches may be utilized at the BSs 322, 323 to locate the device. Exemplary measurements are generally supported via existing UL transmissions (e.g., ranging sequence) or new signals designed specifically for the LBS measurements. Exemplary methods may include but are not limited to, TDOA, TOA, RTD, AOA, RSSI, Advanced forward link trilateration (“A-FLT”), Enhanced observed time difference (“EOTD”), Observed time difference of arrival (“OTDOA”), time of arrival (“TOA”), uplink-TOA and uplink-TDOA, Enhanced cell/sector and cell-ID, etc., and hybrid combinations thereof.

For example, in one embodiment of the present subject matter, a BS 322, 323 may transmit a signal, such as a Fast_Ranging_IE signal, to a mobile device or station 310, and the mobile station 310 may transmit another signal, such as a ranging signal, in response thereto. If the characteristics of the ranging signal are known to components of the network, such as an LMU, then the uplink signal TOA may be determined. Therefore, as the serving BS receives the ranging signal, the serving BS may measure the uplink transmission timing adjustment that provides the range of the mobile station 310 from the respective BS. While uplink measurements are being performed, an exemplary downlink OTDOA location method may also be invoked, and therefore, both uplink and downlink measurements may be utilized to determine a location of the mobile station 310. Embodiments of the present subject matter may thus provide location solutions for a TDD WiMAX network with or without Multiple Input, Multiple Output (“MIMO”) or Adaptive Antenna System (“AAS”) antenna technologies.

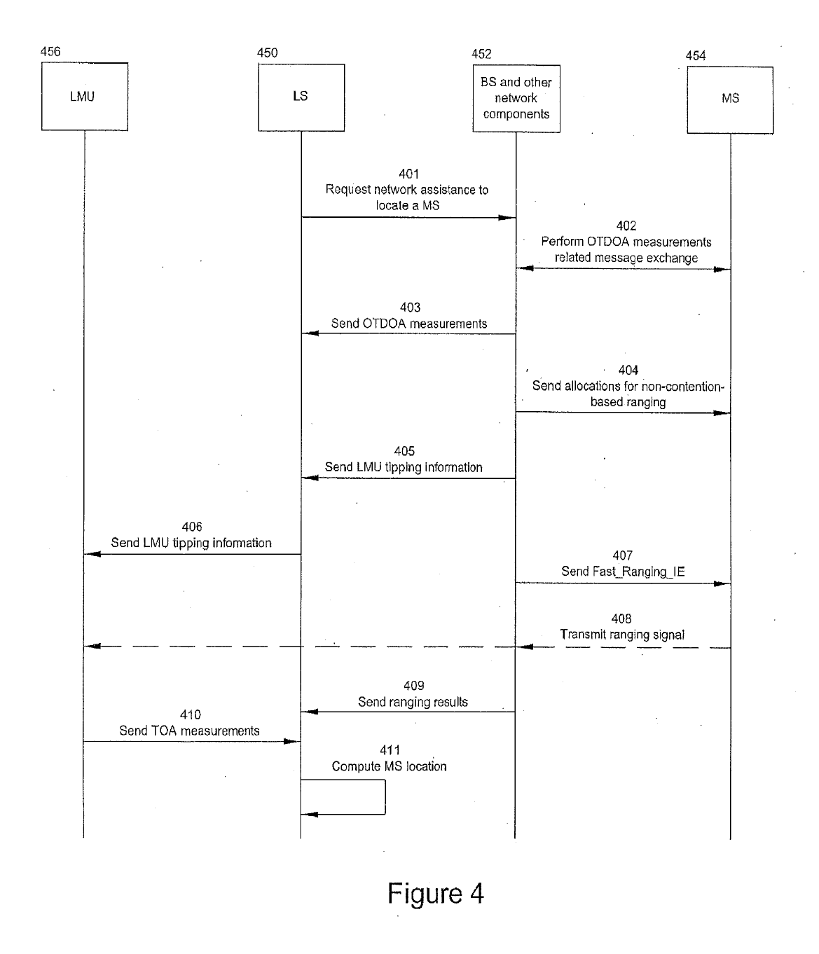

FIG. 4 is a diagram illustrating one method for hybrid signal based location in a WiMAX network. With reference to FIG. 4, a LS 450 may at step 401 transmit a request for network assistance to a BS 452. At step 402, the mobile station 454 may perform OTDOA measurements and send such measurements to the BS 452 or other network components. These OTDOA measurements may then be provided to the LS 450 at step 403. One exemplary downlink OTDOA location technique is described in further detail in co-pending U.S. Application Nos. 61/055,658 and 12/104,250, the entirety of each are incorporated herein by reference. These OTDOA measurements may be performed independently of any of the identified steps in FIG. 4. These downlink OTDOA measurements may provide additional hyperbolas or surfaces which will increase yield and accuracy of a location computation for the mobile station 454. One advantage of an LMU based uplink TOA approach for embodiments of the present subject matter is that the LMUs may provide accurate downlink timing measurements if the downlink frame transmission times are not GPS synchronized among the base stations; therefore, if the OTDOA feature is supported by the network and the mobile station 454, the OTDOA measurements are highly desirable even if the downlink is not synchronized. Further, adding the OTDOA process with the uplink TOA process may increase the latency of location response of the LS 450. To mitigate any delay in location of the mobile station 454, OTDOA measurements may also be performed during the performance of steps 404-410.

WiMAX networks offer different methods or techniques of ranging, however, most are contention based, and one is non-contention based. The non-contention based ranging technique utilizes dedicated data regions for the transmission of the ranging signal and is generally a suitable candidate for uplink based location. This type of ranging may also be triggered by the Fast_Ranging_IE sent by the BS 452. For example, in step 404, the BS 452 may transmit ranging related parameters to a mobile station 454. For example, the BS 452 may transmit allocations for non-contention based ranging to the MS 454. This may be performed utilizing a UL-MAP IE signal and/or UCD. The parameters of a UL-MAP IE signal are described in section 8.4.5.4, table 287 of IEEE Std. 802.16e-2005 and the parameters of UCD are described in section 11.3.1, table 353 of the same, the entirety of each are incorporated herein by reference. In one embodiment, the BS 452 may allocate the ranging opportunity sufficiently ahead of actual transmission time so that LMUs 456 in the respective network may possess an adequate time to tune to the uplink signal and collect samples prior to transmission of a ranging signal from the MS 454.

If, however, sufficient allocation of a ranging opportunity is not possible, it is noted that because the frequency reuse factor is unity for WiMAX networks and both the uplink and downlink signals may be transmitted in the same band for TDD, certain embodiments of the present subject matter may instruct the LMUs 456 to continuously collect and save baseband samples in a circular buffer. Thus, once the tipping information arrives at the LMUs 456 a few hundred milliseconds after the actual transmission of the ranging signal, the LMUs 456 may stop collection and search for the correlation peak in the previously stored data.

Tipping information may be transmitted from the BS 452 to the LS and then to the LMUs 456 in steps 405 and 406. Once tipping information arrives at the LMU 456, the LMUs 456 may search for the TOA of a ranging signal in previously stored data. LMU tipping information is generally a set of parameters that defines a ranging signal transmitted by a MS 454. An LMU 456 may utilize tipping information to recreate the transmitted signal by the MS 454. Table 1 below provides a non-exhaustive list of exemplary tipping information for uplink measurement based location.

TABLE 1

| Parameter Name | Comment |
|---|---|
| CID | UL-MAP IE, section 8.4.5.4, table 287 of |
| | IEEE Std. 802.16e-2005. |
| Serving BSID | Identifier for the serving BS |
| OFDMA symbol offset | UL-MAP IE, section 8.4.5.4, table 287 of |
| Subchannel offset | IEEE Std. 802.16e-2005. |
| No. OFDMA symbols | UIUC, section 8.4.5.4.3 of IEEE Std. |
| No. subchannels | 802.16e-2005. |
| Ranging method | |
| Dedicated | |
| ranging indicator | |
| CDMA_Allocation_IE | UL-MAP IE, section 8.4.5.4, table 287 |
| | of IEEE Std. 802.16e-2005. |
| | UIUC = 12, section 8.4.5.4.3 of IEEE Std. |
| | 802.16e-2005. |
| Fast_Ranging_IE | UL-MAP IE, UIUC = 15, Section |
| | 8.4.5.4.21 of IEEE Std. 802.16e-2005. |
| Permutation base | Section 11.3.1, Table 353 of IEEE Std. |
| (UL_PermBase) | 802.16e-2005. |
| Action time | Section 6.3.2.3.52, Table 109 of IEEE |
| | Std. 802.16e-2005. |
| Approximate | This parameter may be derived from |
| ranging signal | other parameters such as, but not limited |
| transmission time | to, approximate clock of the base |
| | station, allocation start time, duration |
| | of the allocation, etc. Section 10.3.4.1 |
| | and table 342 of IEEE Std. 802.16e- |
| | 2005. |

The parameters listed above in Table 1 are generally dynamic; however, LMUs 456 may also utilize any one or combination of the following semi-static parameters: the BS identity of the base stations, the location of any one of the BSs, the azimuth of the base station sector antennas, downlink preamble sequence of each BS, system bandwidth, sampling frequency, FFT size, etc. These semi-static parameters may be periodically passed to an LS as system log files.

With continued reference to FIG. 4, at step 407, a BS 452, such as a serving BS, may transmit a signal, such as but not limited to a Fast_Ranging_IE signal, to the MS 454 to trigger the transmission of the ranging signal. In response, at step 408 the MS 454 may transmit a ranging signal. The ranging signal may be received by any of the BSs 452, serving or neighboring base stations and/or the LMUs 456. The serving BS 452 may then transmit at step 409 another message or signal, such as a MOB_ASC-REP message, including timing adjust parameters for the BSs 452 that detected the ranging signal. Generally, the standard supports the creation of this message when association level 2 is used. The MOB_ASC-REP message may be transmitted with the ranging results from the serving BS 452. Another message, RNG-RSP, is also created for every ranging event. The RNG-RSP message also provides a timing adjust field, but this field represents a relative timing adjust. Exemplary uplink TOA location methods generally require the absolute timing adjustment representing the round trip time, however, it is envisioned that the RING-RSP message may also be utilized in embodiments of the present subject matter with adequate compensation for the relative nature of the message.

The LMUs 456 may then determine the uplink TOAs of the ranging signal and send the TOA values to the LS at step 410. At step 411, the location of the MS 454 may then be determined utilizing any one or combination of an OTDOA of a neighboring BS's downlink signal, a range of the MS from the serving BS (e.g., from OTDOA measurements), a downlink transmission time of the neighboring BSs as measured by the LMU, the uplink TOA of the ranging signal as measured by the LMU, and/or timing adjust of the MS. Generally, the OTDOA of a neighboring BS's downlink signal, a range of the MS from the serving BS (e.g., from OTDOA measurements), and a downlink transmission time of the neighboring BSs as measured by the LMU are downlink OTDOA related measurements; and the uplink. TOA of the ranging signal as measured by the LMU, and/or timing adjust of the MS measurements are uplink TOA related measurements. If, however, the OTDOA measurements are unavailable, the uplink TOA related parameters may still be adequate for a multiple range estimation location embodiment. In this embodiment, the OTDOA measurements would provide additional surfaces (e.g., range rings or a combination of range rings and TDOA hyperbolas) to improve the location accuracy.

Secondary site hearability of embodiments of the present subject matter is acceptable as the ranging signal is designed to be heard at multiple base stations. Several approaches, however, may also be utilized to boost the uplink signal detection probability. One approach to increasing the probability of ranging signal detection is to increase the ranging sub-carrier power and/or increase the power of the ranging signal. Another approach to increase detection probability may be to transmit a series of ranging signals rather than a single ranging signal. For example, if the transmission is sequential or if the transmission follows a periodic pattern, then the transmission of multiple ranging signals may be quite useful. The ranging signal may be, in one embodiment, transmitted for all the symbols of a UL sub frame, or the ranging signal may be transmitted in the first 8 symbols of 10 consecutive UL sub frames. A further embodiment may also provide a repetition feature as the appropriate hooks are in place in the Fast_Ranging_IE message.

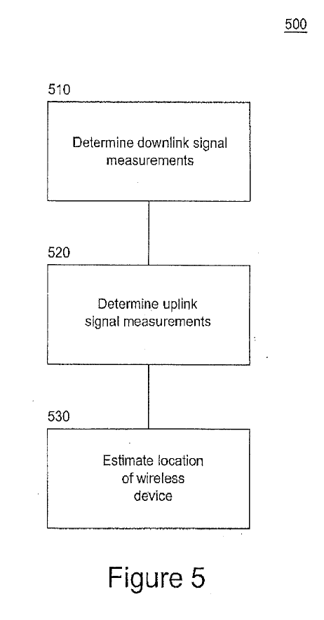

FIG. 5 is a diagram of another embodiment of the present subject matter. With reference to FIG. 5, a method 500 is provided for estimating a location of a wireless device receiving signals from plural nodes of a WiMAX communication system. These nodes may be base stations, base station sectors, and combinations thereof. At step 510, downlink signal measurements may be determined which include a range of the wireless device from a serving node, an OTDOA measurement of a signal from one or more neighboring nodes, and a transmission time of the signal from the one or more neighboring nodes. At step 520, uplink signal measurements may be determined which include a TOA measurement of a ranging signal from the wireless device, and a timing adjust parameter of the wireless device. Of course, the downlink signal measurements may be determined independently of the uplink signal measurements in one embodiment. At step 530, a location of the wireless device may then be estimated as a function of the determined downlink and uplink signal measurements.

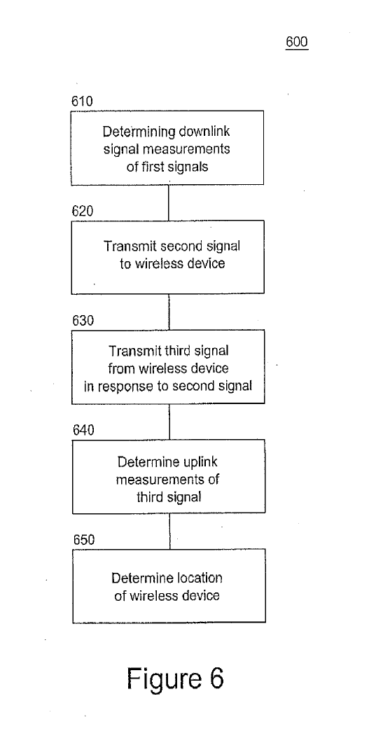

FIG. 6 is a diagram of another embodiment of the present subject matter. With reference to FIG. 6, a method 600 is provided for estimating a location of a wireless device receiving signals from plural nodes of a WiMAX communication system. These nodes may be base stations, base station sectors, and combinations thereof. Exemplary wireless devices may be, but are not limited to, a cellular device, text messaging device, computer, portable computer, vehicle locating device, vehicle security device, communication device, and wireless transceiver. The method may include, at step 610, determining downlink signal measurements of first signals received by the wireless device from the plural nodes, and at step 620 transmitting a second signal from at least one of the plural nodes to the wireless device. Exemplary downlink signal measurements may include one or more of a range of the wireless device from a serving node, an OTDOA measurement of a signal from one or more neighboring nodes, a transmission time of the signal from the one or more neighboring nodes, and combinations thereof. An exemplary second signal may be, but is not limited to, a Fast_Ranging_IE signal. In a further embodiment, step 610 may include determining OTDOA ranges and/or hyperbolae using information received from a scanning result report (MOB_SCN-REP).

At step 630, a third signal may be transmitted from the wireless device in response to the second signal, and uplink signal measurements determined as a function of the third signal at step 640. Exemplary uplink signal measurements may include one or more of a TOA measurement of a ranging signal from the wireless device, a timing adjust parameter of the wireless device, and combinations thereof. Further, the downlink signal measurements may be determined independently of the uplink signal measurements in one embodiment. At step 650, a location of the wireless device may be determined as a function of the determined downlink and uplink measurements. In one embodiment, the method 600 may further include the steps of transmitting allocations for non-contention based ranging to the wireless device and transmitting tipping information to one or more LMUs. This transmission of tipping information may include recreating signals transmitted by the wireless device as a function of information selected from the group consisting of: connection identifier (“CID”), base station identifier (“BSID”), azimuth of base station sector antennas, downlink preamble sequence of base stations, system bandwidth, sampling frequency, fast-Fourier transformation size, orthogonal frequency division multiple access (“OFDMA”) symbol offset, sub-channel offset, number of OFDMA symbols, number of sub-channels, ranging method, dedicated ranging indicator, CDMA_Allocation_IE parameter, Fast_Ranging_IE parameter, Permutation base, action time, approximate ranging signal transmission time, and combinations thereof. Another embodiment may also include the step of transmitting a request for network assistance to locate the wireless device to at least one of the plural nodes.

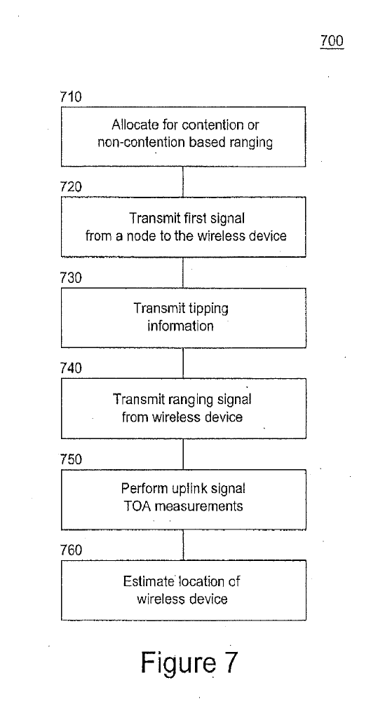

FIG. 7 is a diagram of another embodiment of the present subject matter. With reference to FIG. 7, a method 700 is provided for estimating a location of a wireless device receiving signals from plural nodes of a WiMAX communication system. The plural nodes may or may not be synchronized as a function of information received from a satellite signal or information received from a component of the system. At step 710, the method may include allocating for contention or non-contention based ranging to the wireless device, and at step 720, a first signal may be transmitted from at least one of the plural nodes to the wireless device. In one embodiment, the first signal may be a Fast_Ranging_IE signal. At step 730, tipping information may be transmitted to one or more LMUs (co-located or otherwise with a node and/or sparsely located within the network). In another embodiment, step 710 may include transmitting ranging related parameters to the wireless device and/or instructing one or more LMUs to collect baseband samples of one or more ranging signals transmitted by the wireless device in a buffer. In this embodiment, uplink signal TOA measurements of the one or more ranging signals may be recreated as a function of the tipping information and the stored baseband samples correlated against the recreated signals.

In one embodiment, step 710 may include recreating signals transmitted by the wireless device as a function of any one or combination of the following: connection identifier (“CID”), base station identifier (“BSID”), azimuth of base station sector antennas, downlink preamble sequence of base stations, system bandwidth, sampling frequency, fast-Fourier transformation size, orthogonal frequency division multiple access (“OFDMA”) symbol offset, sub-channel offset, number of OFDMA symbols, number of sub-channels, ranging method, dedicated ranging indicator, CDMA_Allocation_IE parameter, Fast_Ranging_IE parameter, Permutation base, action time, and approximate ranging signal transmission time. A ranging signal may then be transmitted from the wireless device in response to the second signal at step 740. Step 740 may also include transmitting a plurality of ranging signals. For example, these plural transmitted ranging signals may be transmitted for all the symbols of an uplink sub-frame, transmitted in a first predetermined number of symbols for a second predetermined number of uplink sub-frames, transmitted periodically, or transmitted repetitively as a function of information in the second signal.

Uplink signal TOA measurements of the ranging signal may be performed as a function of the tipping information at step 750, and a location of the wireless device estimated as a function of the determined uplink measurements at step 760. Further, the determined uplink signal TOA measurements may further include a timing adjust parameter of the wireless device. Another embodiment of the present subject matter may include increasing the power or ranging sub-carrier power of the ranging signal to increase the probability of detection of the ranging signal. In one embodiment of the present subject matter, the method may include determining downlink signal measurements of second signals received by the wireless device from the plural nodes. These downlink signal measurements may be determined independently of the uplink signal measurements. Of course, the location of the wireless device may be determined from downlink and/or uplink signal measurements. Additionally, this step of determining downlink signal measurements may include determining an OTDOA hyperbola using information received from a scanning result report. Further, these determined downlink signal measurements may include a range of the wireless device from a serving node, an OTDOA measurement of a signal from one or more neighboring nodes, a transmission time of the signal from the one or more neighboring nodes, and combinations thereof. To make OTDOA measurements meaningful, LMUs, which may be capable of performing the functions of an NSU, may also measure the downlink signal. In one embodiment, the method 700 may also include determining transmission time of the ranging signal as a function of: a base station timing reference, an allocation start time, duration of the allocation, or determined uplink and downlink measurements (as applicable). It may be expected that the timing adjust may assist in the determination of a device's range from a base and may be provided by a respective network. In the event that such information is not provided, an approximate location of the device may be determined utilizing Cell-ID, etc. Additionally, as LMUs may measure both uplink and downlink transmission times, embodiments of the present subject matter may estimate or predict transmission time of the device therefrom. Other embodiments may estimate or predict transmission time of the ranging signal from a clock or timing reference of a node, allocation start time and/or duration of the allocation. This transmission time may then be utilized to reduce or track out any range bias in location determinations.

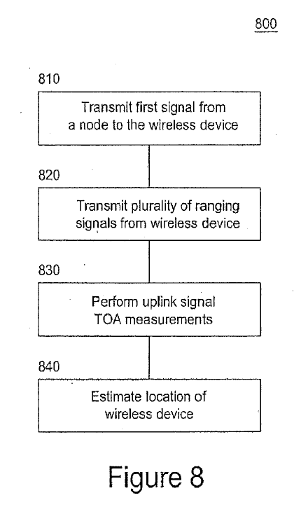

FIG. 8 is a diagram of a further embodiment of the present subject matter. With reference to FIG. 8, a method 800 for estimating a location of a wireless device receiving signals from plural nodes of a WiMAX communication system is provided. At step 810, a first signal may be transmitted from at least one of the plural nodes to the wireless device. At step 820, a plurality of ranging signals may then be transmitted from the wireless device in response to the first signal. In one embodiment, step 820 may further comprise transmitting ranging signals for all the symbols of an uplink sub-frame, transmitting ranging signals in a first predetermined number of symbols for a second predetermined number of uplink sub-frames, transmitting ranging signals periodically, or transmitting ranging signals repetitively as a function of information in the second signal. Uplink signal TOA measurements of the ranging signal may be performed at step 830, and at step 840, a location of the wireless device estimated as a function of the determined uplink measurements. In another embodiment, the method may include allocating for contention or non-contention based ranging to the wireless device, and transmitting tipping information to one or more location measurement units. Further, the method may, in another embodiment, include determining downlink signal measurements that may include one or more of a range of the wireless device from a serving node or neighboring node, an OTDOA measurement of a second signal from one or more neighboring nodes, and a transmission time of the second signal from the one or more neighboring nodes.

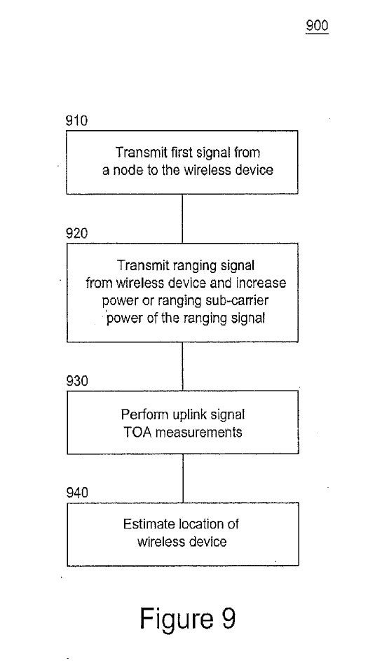

FIG. 9 is a diagram of an additional embodiment of the present subject matter. With reference to FIG. 9, a method 900 is provided for estimating a location of a wireless device receiving signals from plural nodes of a WiMAX communication system. At step 910, a first signal may be transmitted from at least one of the plural nodes to the wireless device. At step 920, a ranging signal may then be transmitted from the wireless device in response to the first signal, and the power or ranging sub-carrier power of the ranging signal may be increased to thereby increase a probability of detection of the ranging signal. Of course, plural ranging signals may be transmitted from the wireless device in response to the second signal and in such embodiments (e.g., transmitting ranging signals for all the symbols of an uplink sub-frame, transmitting ranging signals in a first predetermined number of symbols for a second predetermined number of uplink sub-frames, transmitting ranging signals periodically, transmitting ranging signals repetitively as a function of information in the second signal) the power or ranging sub-carrier power of the plural transmitted ranging signals may also be increased. Uplink signal TOA measurements of the ranging signal may be performed at step 930, and at step 940, a location of the wireless device estimated as a function of the determined uplink measurements. In another embodiment, the method may include allocating for contention or non-contention based ranging to the wireless device, and transmitting tipping information to one or more location measurement units. Additionally in a further embodiment, downlink signal measurements may be determined that include one or more of a range of the wireless device from a serving node, an OTDOA measurement of a second signal from one or more neighboring nodes, and a transmission time of the second signal from the one or more neighboring nodes.

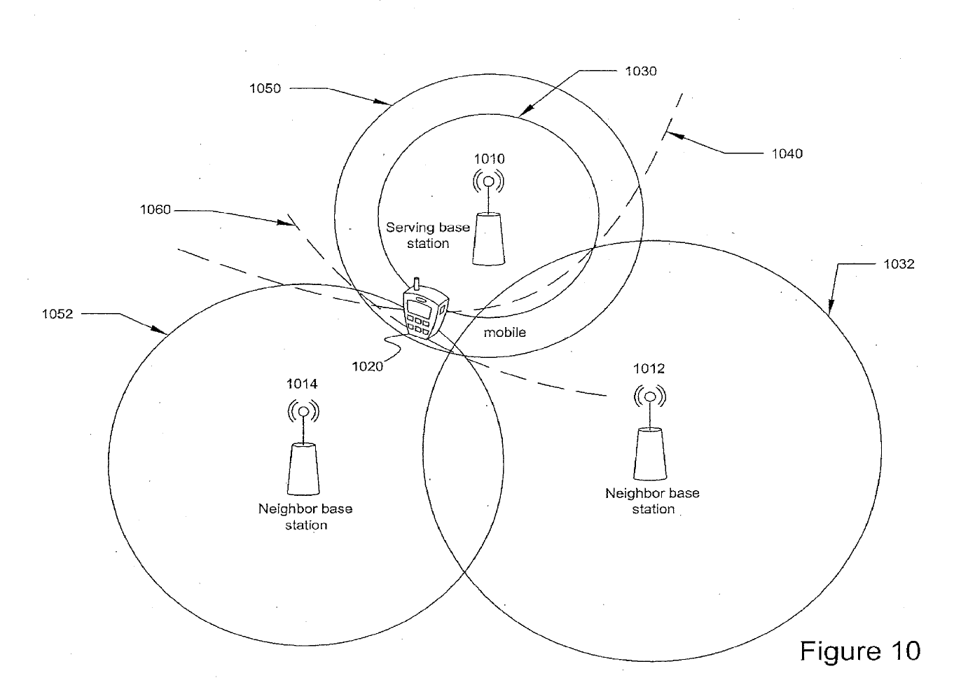

FIG. 10 is an illustration of an exemplary hybrid location technique according to one embodiment of the present subject matter. With reference to FIG. 10, an exemplary communications system may include three BSs 1010, 1012, 1014. BS 1010 is the base station serving a mobile appliance 1020 and BSs 1012, 1014 are the neighboring base stations. In this example, at time t₁, the mobile appliance 1020 may hear signals transmitted from BSs 1010, 1012 and perform downlink OTDOA measurements on these signals. Two range rings 1030, 1032 and a hyperbola 1040 may be derived from these OTDOA measurements. Any two of these three curves or surfaces are independent and may be utilized for location determination of the mobile appliance 1020. Similarly, at time t₂, which may or may not be different than t₁, any LMUs (co-located or otherwise) (not shown) may have made uplink TOA measurements from signals transmitted by the mobile appliance 1020. In this non-limiting example, it may be assumed that the range information or the timing adjustment or advance may be available at or around time t₂. The downlink channel condition at time t₁ and uplink channel condition at time t₂ may be different due to mobile movement, different operating frequency, and environmental variations. In this non-limiting example, it may also assumed that the LMUs at BSs 1010, 1014 can detect the uplink signal and make TOA measurements, Two range rings 1050, 1052 and a hyperbola 1060 may then be derived from these LMU measurements. Any two of these three curves are independent and may then be utilized for location determination of the mobile appliance 1020. An exemplary method according to embodiments of the present subject matter may utilize any combination of the four range rings and two hyperbolas to determine the mobile appliance's location. Thus, if the OTDOA measurements include a range of the mobile appliance 1020 from the serving site 1010, range rings for all the neighboring sites 1012, 1014 may be computed. Similarly, if the mobile appliance's transmit time, range from the serving site 1010, or the timing advance parameter is known, uplink TOA measurements made by the LMUs may also provide the range rings. Moreover, any TDOA measurement, uplink or downlink, may generally provide a hyperbola; and thus, any combination of range rings and hyperbolas may be utilized to determine the location of the mobile appliance 1020 in embodiments of the present subject matter.

It should be noted that the LMU measurements and the downlink OTDOA measurements do not have to be performed simultaneously. For example, if the mobile appliance is static or stationary, measurements made at different times may be as useful for hybrid location technique as the measurements made at the same time.

In the event that a target mobile appliance does not support an OTDOA feature or if the OTDOA measurements are unavailable, the mobile appliance may be located using the LMU measurements alone. Sector geometry is often helpful if the number of participating sites is less than three. In the event that LMUs are not installed in the network or the LMU measurements are unavailable, the mobile appliance may be located using the OTDOA measurements alone. If both the OTDOA and LMU measurements are available, an exemplary hybrid location method according to an embodiment of the present subject matter may be exploited to improve the yield and accuracy of the determined location of the mobile appliance; therefore, in the above example, a hybrid approach may provide three independent range rings which can unambiguously determine the location of the MS.

As shown by the various configurations and embodiments illustrated in FIGS. 1-10, a system and method for locating a wireless device in a WiMAX network using uplink signals have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A method for estimating a location of a wireless device receiving signals from plural nodes of a Worldwide Interoperability for Microwave Access (“WiMAX”) communication system, the method comprising:
(a) allocating for contention or non-contention based ranging to the wireless device;
(b) transmitting a first signal from at least one of the plural nodes to the wireless device;
(c) transmitting tipping information to one or more location measurement units (“LMU”);
(d) transmitting a ranging signal from the wireless device in response to the first signal;
(e) performing uplink signal time of arrival (“TOA”) measurements of the ranging signal as a function of the tipping information; and
(f) estimating a location of the wireless device as a function of the determined uplink measurements.

2. The method of claim 1 further comprising the step of determining downlink signal measurements of second signals received by the wireless device from the plural nodes, wherein the estimated location of the wireless device is determined as a function of the determined uplink and downlink measurements.

3. The method of claim 1 wherein the step of transmitting tipping information further comprises recreating signals transmitted by the wireless device as a function of information selected from the group consisting of: connection identifier (“CID”), base station identifier (“BSID”), azimuth of base station sector antennas, downlink preamble sequence of base stations, system bandwidth, sampling frequency, fast-Fourier transformation size, orthogonal frequency division multiple access (“OFDMA”) symbol offset, sub-channel offset, number of OFDMA symbols, number of sub-channels, ranging method, dedicated ranging indicator, CDMA_Allocation_IE parameter, Fast_Ranging_IE parameter, Permutation base, action time, approximate ranging signal transmission time, and combinations thereof.

4. The method of claim 1 wherein the step of allocating further comprises:
(i) transmitting ranging related parameters to the wireless device.

5. The method of claim 4 wherein the step of allocating further comprises:
(i) instructing one or more LMUs to collect and store baseband samples of one or more ranging signals transmitted by the wireless device in a buffer.

6. The method of claim 5 wherein the step of performing uplink signal TOA measurements further comprises:
(i) recreating the one or more ranging signals as a function of the tipping information; and
(ii) correlating the stored baseband samples against the recreated one or more ranging signals.

7. The method of claim 1 wherein the first signal is a Fast_Ranging_IE signal.

8. The method of claim 1 wherein the step of transmitting a ranging signal further comprises transmitting a plurality of ranging signals.

9. The method of claim 8 wherein the plural transmitted ranging signals are transmitted for all the symbols of an uplink sub-frame, transmitted in a first predetermined number of symbols for a second predetermined number of uplink sub-frames, transmitted periodically, or transmitted repetitively as a function of information in the second signal.

10. The method of claim 1 further comprising the step of increasing the power or ranging sub-carrier power of the ranging signal to increase the probability of detection of the ranging signal.

11. The method of claim 2 wherein the step of determining downlink signal measurements further comprises determining an OTDOA hyperbola using information received from a scanning result report.

12. The method of claim 2 wherein the step of determining downlink signal measurements further comprises determining an OTDOA range using information received from a scanning result report.

13. The method of claim 1 wherein at least one of the LMUs is not co-located with a node.

14. The method of claim 1 wherein the plural nodes are synchronized as a function of information received from a satellite signal or information received from a component of the system.

15. The method of claim 2 wherein the determined downlink signal measurements include one or more of: a range of the wireless device from a serving node, a range of the wireless device from a neighboring node, an observed time difference of arrival (“OTDOA”) measurement of a signal from one or more neighboring nodes, a transmission time of the signal from the one or more neighboring nodes, and combinations thereof.

16. The method of claim 2 wherein the downlink signal measurements are determined independently of the uplink signal measurements.

17. The method of claim 1 wherein the determined uplink signal TOA measurements further include a timing adjust parameter of the wireless device.

18. The method of claim 1 further comprising the step of determining transmission time of the ranging signal as a function of: a base station timing reference, an allocation start time, or duration of the allocation.

19. The method of claim 2 further comprising the step of determining transmission time of the ranging signal as a function of: a base station timing reference, an allocation start time, duration of the allocation, or determined uplink and downlink measurements.

20. A method for estimating a location of a wireless device receiving signals from plural nodes of a Worldwide Interoperability for Microwave Access (“WiMAX”) communication system, the method comprising:
(a) transmitting a first signal from at least one of the plural nodes to the wireless device;
(b) transmitting a plurality of ranging signals from the wireless device in response to the first signal;
(c) performing uplink signal time of arrival (“TOA”) measurements of the ranging signal; and
(d) estimating a location of the wireless device as a function of the determined uplink measurements.

21. The method of claim 20 further comprising the step of:
(e) determining downlink signal measurements including one or more of:
(i) a range of the wireless device from a serving node,
(ii) an observed time difference of arrival (“OTDOA”) measurement of a second signal from one or more neighboring nodes, and
(iii) a transmission time of the second signal from the one or more neighboring nodes,
wherein the estimated location of the wireless device is determined as a function of the determined uplink and downlink measurements.

22. The method of claim 20 wherein the step of transmitting a plurality of ranging signals is selected from the group consisting of: transmitting ranging signals for all the symbols of an uplink sub-frame, transmitting ranging signals in a first predetermined number of symbols for a second predetermined number of uplink sub-frames, transmitting ranging signals periodically, and transmitting ranging signals repetitively as a function of information in the second signal.

23. The method of claim 20 further comprising the steps of:
(i) allocating for contention or non-contention based ranging to the wireless device; and
(ii) transmitting tipping information to one or more location measurement units.

24. A method for estimating a location of a wireless device receiving signals from plural nodes of a Worldwide Interoperability for Microwave Access (“WiMAX”) communication system, the method comprising:
(a) transmitting a first signal from at least one of the plural nodes to the wireless device;
(b) transmitting a ranging signal from the wireless device in response to the first signal and increasing the power or ranging sub-carrier power of the ranging signal to increase a probability of detection of the ranging signal;
(c) performing uplink signal time of arrival (“TOA”) measurements of the ranging signal; and
(d) estimating a location of the wireless device as a function of the determined uplink measurements.

25. The method of claim 24 further comprising the step of
(e) determining downlink signal measurements including one or more of:
(i) a range of the wireless device from a serving node,
(ii) an observed time difference of arrival (“OTDOA”) measurement of a second signal from one or more neighboring nodes, and
(iii) a transmission time of the second signal from the one or more neighboring nodes,
wherein the estimated location of the wireless device is determined as a function of the determined uplink and downlink measurements.

26. The method of claim 24 wherein the step of transmitting a ranging signal further comprises transmitting a plurality of ranging signals selected from the group consisting of: transmitting ranging signals for all the symbols of an uplink sub-frame, transmitting ranging signals in a first predetermined number of symbols for a second predetermined number of uplink sub-frames, transmitting ranging signals periodically, and transmitting ranging signals repetitively as a function of information in the second signal.
